(19) United States
(12) Patent Application Publication
(10) Pub. No.: US 2005/0204032 A1
(43) Pub. Date: Sep. 15, 2005

(54) Remote device management of software only solution

(76) Inventor: Attaullah Mirza-Baig, Fremont, CA (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/620,563

(22) Filed: Jul. 17, 2003

(51) Int. Cl. G06F 15/173; G06F 15/16

(52) U.S. Cl. 709/224; 709/218

(57) ABSTRACT

A novel plug-in for use with a standard network management software and a process for monitoring network devices utilizing such a plug-in. The standard network management software will already exist on a network and will operate to discover all devices on a network and store information about the discovered devices in a database. The plug-in can access the database and identify a first set of network devices from the database, and poll the first set of network devices for information. The plug-in can further utilize the information from the polled first set of network devices to set predetermined properties for at least one of the first set of network devices, and can determine error conditions in the first set of network devices from the information from the polled first set of network devices. The plug-in can further report at least one of the error conditions to a device management facility by an e-mail message, that can be encrypted. The plug-in can report both high priority error conditions as they occur, and/or can report lower priority error conditions only if they persist for a predetermined period of time.

### REFERENCE TO COMPUTER PROGRAM LISTING APPENDIX

The present document hereby incorporates herein by reference the material on the provided compact disc in the appendix as a computer program listing.

### BACKGROUND OF THE INVENTION

1. Field of the Invention

The present invention is directed to a remote device management solution requiring only software to operate in conjunction with standard network management software.

2. Discussion of the Background

In many environments plural network devices such as printers, facsimiles, multi-function machines, etc., are connected to a network server. Conventionally, the network server gathers information from the network devices utilizing dedicated hardware for different types of solutions. For example, a remote printer management solution utilizes dedicated hardware to gather information from the network devices to control, e.g., printing operations.

In such background systems, requiring the use of the dedicated hardware obviously results in increases in costs.

With reference to FIG. 1 in the present specification, such a background network server system is shown. As shown in FIG. 1 a network 1 includes a network server 2 connected to different network devices 15, 17. Those network devices 15, 17 can be printers, facsimiles, multi-function machines, etc. A dedicated hardware with its own software 5 is also connected to the network server 2 and is connected to the network devices 15, 17. That dedicated hardware and software 5 gathers information about the network devices 15, 17 to control, e.g., printing operations.

As also shown in FIG. 1 the network 1 can be connected to a remote device management center 30 through a communication channel 20, such as the Internet. The remote device management center 30 in turn includes a remove device management center server 32.

The dedicated hardware with its own software 5 as shown in FIG. 1 for example may be a mini PC running a Linux operating system and including appropriate sensing, polling, etc. hardware and software.

Most network servers, however, include network management software such as HP Open View™. With reference to FIG. 1 the network server 2 also includes the network management software 13 and which is connected to a database 18. HP Open View™ is a software that runs on a Windows/Linux/Unix or Solaris server. That software discovers devices on the networks and monitors the discovered devices by periodically polling the devices.

### SUMMARY OF THE INVENTION

The inventors of the present invention have recognized that as existing network systems have HP Open View™ or similar network management software, such network management software can be used as a platform to develop a plug-in that can gather information from the network devices. That gathered information could then be utilized in many aspects, such as allowing sending messages for error or condition monitoring to a remote device management center about the network devices, for example in an encrypted e-mail. With such a solution the requirement for dedicated hardware for a remote device management solution, as an example, can be eliminated and a pure software only solution for a remote device management can be realized.

Accordingly, one object of the present invention is to provide a novel remote device management operation that is simple to utilize and install on a network system.

A further object of the present invention is to provide a novel remote device management system that does not require the use of dedicated hardware.

A further object of the present invention is to provide a novel remote device management system that is a software only solution.

To achieve the above and other objects, the present invention sets forth a novel plug-in for use with a standard network management software and a process for monitoring network devices utilizing such a plug-in. The standard network management software will already exist on a network and will operate to discover all devices on a network and store information about the discovered devices in a database. The plug-in can access the database and identify a first set of network devices from the database, and poll the first set of network devices for information. The plug-in can further utilize the information from the polled first set of network devices to set predetermined properties for at least one of the first set of network devices, and can determine error conditions in the first set of network devices from the information from the polled first set of network devices. The plug-in can further report at least one of the error conditions to a device management facility by an e-mail message, that can be encrypted. The plug-in can report both high priority error conditions as they occur, and/or can report lower priority error conditions only if they persist for a predetermined period of time.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 shows a background remote device management system;

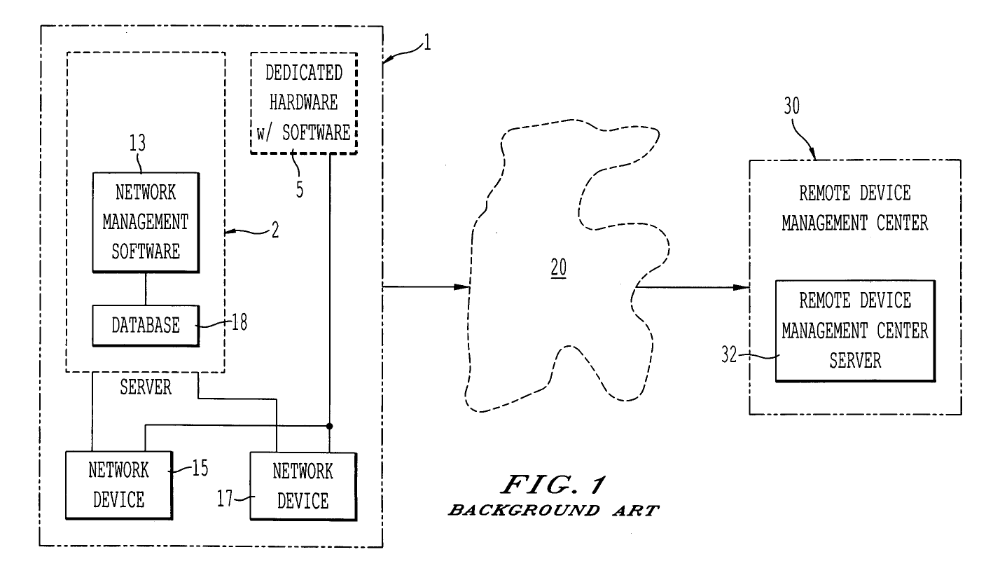

FIG. 2 shows a block diagram system according to the present invention; and

FIG. 3 shows in flow chart describing an operation of the plug-in of FIG. 2.

### DESCRIPTION OF THE PREFERRED EMBODIMENTS

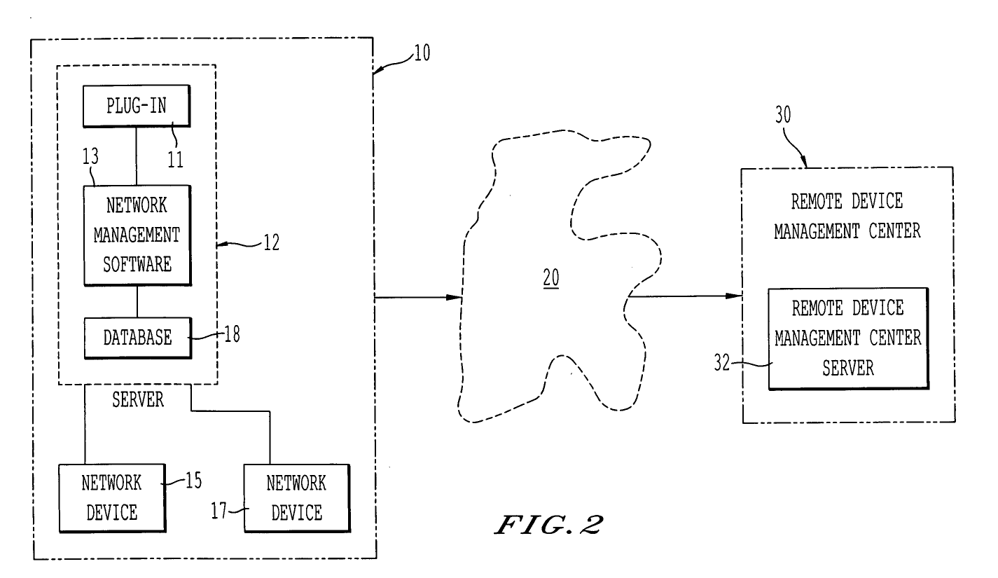

Referring now to the drawings, wherein like reference numerals designate identical or corresponding parts throughout the several views, and more particularly to FIG. 2 thereof, a block diagram of the system of the present invention is set forth.

Element 10 in FIG. 2 shows a network in which a plug-in 11 of the present invention can be installed. As shown in FIG. 2 the network 10 includes a network server 12 connected to a database 18 and to different network devices 15, 17. The network devices can be any type of printer, facsimile, multi-function machine, etc. The network server includes a network management software 13, such as HP Open View™, and includes the plug-in 11.

The present invention is in specific detail directed to the plug-in 11 that can be installed in the network server 10 and that allows remote device management to be realized without requiring the use of any additional dedicated hardware. The plug-in 11 essentially utilizes the network management software 13, in this example the HP Open View™, as a platform for its operations. The plug-in can be used with other network management software and is not limited to use with HP Open View™. For example, the plug-in can be used with other standard network management software such as IBM Tivoli NetView, AdventNet, WebNMS, etc.

As also shown in FIG. 2 the network 10 is connected to a remote device management center 30 by a communication channel 20, such as the Internet. The remote device management center 30 includes a remote device management center server 32.

The remote device management center 30 and remote device management center server 32 can be any conventional or existing remote device management center that monitors the operation of the network 10, and particularly the network devices 15, 17 included in that network. The remote device management center 30, as a concrete example, can process fault instructions when one of the network devices 15, 17 suffers a fault and can either send a message to an operator of the network 10 on how to correct the fault or can send a service personnel to service the network device with the fault to correct the fault. The remote device management center 30 can of course provide other functions and operations. Further, the remote device management center 30 can receive information from the network 10 through communication channel 20, for example through the Internet by an e-mail, and thus the network server 12 also includes a mail server. Other communication modes, i.e. wireless, direct line, etc., could also connect the network 10 to the remote device management center 30.

In the present invention a user of the network 10 needs to install the plug-in 11 on an already existing network server 12 that has a network management software 13 such as HP Open View™. Once the plug-in 11 is installed the user can enter an e-mail address of the remote device management center 30, and all error conditions and device information such as counters, toner levels, etc., can be reported in the form of an e-mail message, that can be encrypted, to the remote device management center 30.

The plug-in 11 can be utilized with different network management software 13 but the applicants of the present invention have recognized that it is particularly adapted to HP Open View™. The network management software 13 to which the plug-in 111 can be operated in conjunction with should have a built-in database 18 that can be used to store additional properties required for the plug-in 11 to work. The C API's (Application Programming Interface) of HP Open View™ can be used to poll additional network devices and store properties required for the plug-in 11 in the database 18.

In the operation of the system as shown in FIG. 2 the network management software 13 discovers all network devices on the network and stores information about the discovered network devices in the database 18. The plug-in 11 can operate to retrieve the discovered devices from the database 18 and can identify certain devices. For example, the plug-in can identify as a first set of devices all devices belonging to a particular manufacturer. The plug-in 11 can then poll those devices for additional information. Using the additional information received from the polling operating, the plug-in 11 can set certain pre-defined properties for any of the particular devices. The plug-in can then also determine any error condition by looking at the information provided from the network devices. Immediate error conditions can be pre-defined and can be reported immediately as they occur. As soon as an immediate error is discovered an e-mail message, that can be encrypted, can be sent to the remote device management center 30. Other errors that do not require immediate attention, such as a long remaining error condition that persists for a predetermined period of time, can also be discovered and can be reported by e-mail, again that can be encrypted, after the error is noted as persisting for the predetermined period of time. The process can also be repeated for all of the devices, and particularly for all of the first set of devices, at every poll cycle.

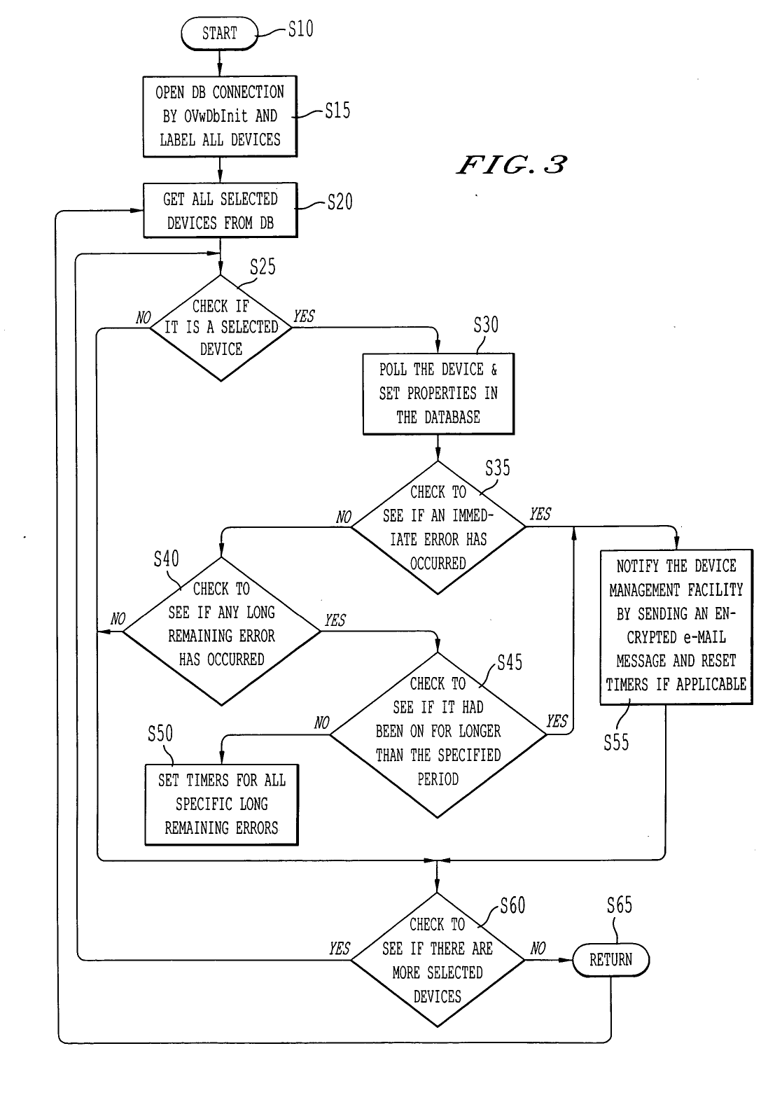

FIG. 3 provides further detailed operation of the plug-in 11.

As shown in FIG. 3 after a start in step S10, in step S15 the database 18 is opened by the command OVwDbInit and all of the selected groups of devices are labeled. This process of labeling all of the selected groups of devices, i.e. labeling a first set of devices, is performed by the plug-in 11. Then, in the step S20, the plug-in 11 can retrieve all of the selected devices from the database. The plug-in 11 can then, in step S25, check if each of the selected devices belongs to the selected group of devices.

If the device belongs to the selected group, YES in step S25, the operation then proceeds to step S30. In step S30 the selected device is polled and properties for the selected device are set in the database. Various properties are set such as deviceSerialNumber, totalCounter, faxCounter, copycounter, various toner levels, deviceStatus, jamStatus, etc.

The operation then proceeds to step S35 in which the plug-in 11 continuously monitors to see if an immediate error occurs in the device of the group. If an immediate error occurs, YES in step S35, the operation then proceeds to step S55 in which the remote device management center 30 is notified of the immediate error by sending an e-mail message, which can be encrypted, and by resetting any applicable timers. Examples of immediate erros to be immediately reported by e-mail may be a toner level and condition or a service call occurred condition.

If no immediate error occurs in step S35, NO in step S35, the operation then proceeds to step S40 in which it is determined whether any long standing error has occurred. An example of a long standing error condition may be a device Down/unreachable condition. If YES in step S40 indicating the presence of a long-standing error, the operation then proceeds to step S45 to determine whether the error has persisted for longer than the specified period of time. If YES in step S45 the operation then again proceeds to step S55 in which the remote device management center 30 is notified by e-mail, that can be encrypted, of the error.

If NO in step S45 indicating that the error has not been present for the predetermined period of time, then the operation proceeds to step S50 in which the timers are set for all of the specific long remaining errors. The timers are used to keep track of how long a long standing error has been present. If a particular long standing error has been present for 5 polling cycles the toner is set to 5 for that particular long standing error.

If a specific device is not from the selected group, NO in step S25, or if no long standing error is occurring in step S40, the operation then proceeds to step S60. After the e-mail is sent in step S55 the operation also proceeds to step S60.

In step S60 it is determined if there are any other devices of the selected group, and if YES in step S60 the operation then returns to step S25. If NO in step S60 the operation then ends for this cycle in step S65, and then the operation then returns to step S20 for a next polling cycle. A polling cycle can range from 10 to 180 minutes, as examples.

With such an operation in the present invention the plug-in 11, which is a pure software solution, can utilize the network management software 13 as a platform to perform a monitoring of the various network devices 15, 17 connected to the network server 12. Thereby no dedicated hardware is required for the monitoring operation.

One actual embodiment of software to implement the present invention is set forth in the attached Appendix of a compact disc setting forth a computer program listing, which is incorporated herein by reference.

Obviously, numerous modifications and variations of the present invention are possible in light of the above teachings. It is therefore to be understood that within the scope of the appended claims, the present invention may be practiced otherwise than as specifically described herein.

1. A plug-in for use with a standard network management software that discovers all devices on a network and that stores information about the discovered devices in a database, comprising:
a first computer control configured to access the database and to identify a first set of network devices from the database;
a second computer control configured to poll the first set of network devices for information.

2. A plug-in according to claim 1, further comprising:
a third computer control configured to utilize the information from the polled first set of network devices to set predetermined properties for at least one of the first set of network devices.

3. A plug-in according to claim 1, further comprising:
a fourth computer control configured to determine error conditions in the first set of network devices from the information from the polled first set of network devices.

4. A plug-in according to claim 3, further comprising:
a fifth computer control configured to report at least one of the error conditions to a device management facility by an e-mail message.

5. A plug-in according to claim 4, wherein the fifth computer control is further configured to report at least a first error condition substantially as the first error condition occurs, and to report at least a second error condition if the second error condition persists for a predetermined period of time.

6. A plug-in according to claim 5, wherein the second to fifth computer controls are repeated for all devices within the first set of network devices at every one of poll cycles.

7. A plug-in according to claim 1, wherein the standard network management software is HP Open View™.

8. A plug-in according to claim 1, wherein the first set of network devices are all the network devices on the network discovered to be manufactured by a same manufacturer.

9. A plug-in according to claim 4, wherein fifth computer control is further configured to encrypt the e-mail message.

10. A plug-in for use with a standard network management software that discovers all devices on the network and that stores information about the discovered devices in a database, comprising:
first computer code means for accessing the database and for identifying a first set of network devices from the database;
second computer code means for polling the first set of network devices for information.

11. A plug-in according to claim 10, further comprising:
third computer control means for utilizing the information from the polled first set of network devices to set predetermined properties for at least one of the first set of network devices.

12. A plug-in according to claim 10, further comprising:
fourth computer control means for determining error conditions in the first set of network devices from the information from the polled first set of network devices.

13. A plug-in according to claim 12, further comprising:
fifth computer control means for reporting at least one of the error conditions to a device management facility by an e-mail message.

14. A plug-in according to claim 13, wherein the fifth computer control means further reports at least a first error condition substantially as the first error condition occurs, and reports at least a second error condition if the second error condition persists for a predetermined period of time.

15. A plug-in according to claim 14, wherein the second to fifth computer control means are repeated for all devices within the first set of network devices at every one of poll cycles.

16. A plug-in according to claim 10, wherein the standard network management software is HP Open View™.

17. A plug-in according to claim 10, wherein the first set of network devices are all the network devices on the network discovered to be manufactured by a same manufacturer.

18. A plug-in according to claim 13, wherein fifth computer control means further encrypts the e-mail message.

19. A process for monitoring network devices on a network, comprising:
installing a plug-in for use with a standard network management software that discovers all network devices on the network and that stores information about the discovered devices in a database, the plug-in comprising:
a first computer control configured to access the database and to identify a first set of network devices from the database;
a second computer control configured to poll the first set of network devices for information.

20. A process according to claim 19, further comprising:
a third computer control configured to utilize the information from the polled first set of network devices to set predetermined properties for at least one of the first set of network devices.

21. A process according to claim 19, further comprising:
a fourth computer control configured to determine error conditions in the first set of network devices from the information from the polled first set of network devices.

22. A process according to claim 21, further comprising:
a fifth computer control configured to report at least one of the error conditions to a device management facility by an e-mail message.

23. A process according to claim 22, wherein the fifth computer control is further configured to report at least a first error condition substantially as the first error condition occurs, and to report at least a second error condition if the second error condition persists for a predetermined period of time.

24. A process according to claim 23, wherein the second to fifth computer controls are repeated for all devices within the first set of network devices at every one of poll cycles.

25. A process according to claim 19, wherein the standard network management software is HP Open View™.

26. A process according to claim 19, wherein the first set of network devices are all the network devices on the network discovered to be manufactured by a same manufacturer.

27. A process according to claim 22, wherein fifth computer control is further configured to encrypt the e-mail message.
